(19) United States
(12) Patent Application Publication
(10) Pub. No.: US 2006/0131774 A1
(43) Pub. Date: Jun. 22, 2006

(54) Method and device for the production of brake linings or clutch linings made of pressing materials that are bonded by means of a bonding agent

(76) Inventors: Wolfgang Hogenkamp, Remscheid (DE); Ulrich Reineke, Overath (DE); Paul Wahle, Koeln (DE); Helmuth Wensch, Bergisch Gladbach (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/512,303

(22) PCT Filed: Apr. 17, 2003
(86) PCT No.: PCT/EP03/04051

§ 371 Date: Dec. 23, 2005

(30) Foreign Application Priority Data
Apr. 25, 2002 (DE) 102 18 642.1

(51) Int. Cl. B29C 37/00

(52) U.S. Cl. 264/109; 425/420

(57) ABSTRACT

A pressing device having a pressure stamp (1), the sides of which are surrounded by a circumferential wall (2). The circumferential wall (2) is movable counter to the direction of movement of the pressure stamp (2) during and/or after the pressing process, a gap (7) being formed between the pressing material and the circumferential wall (2). The vapors radially escape from the friction lining during and/or after the pressing process and are evacuated via the gap (7), the pressure of the pressure stamp being maintained at least at a reduced level during the entire pressing process.

The invention relates to a method of producing friction linings made from pressing material bonded by means of a binder, particularly brake linings or clutch linings, wherein

the pressing material is filled into a mould or receptacle,

the pressing material is pressed with at least one ram-like pressing tool, and

gaseous or vaporous media which are contained in the mould or are produced during the pressing operation are drawn off from the mould.

The invention further relates to apparatus for producing friction linings made from pressing material bonded by means of a binder, particularly brake linings or clutch linings, with

a receptacle or mould to receive the pressing material,

a ram-like pressing tool which can be moved in and out of the mould and compresses the pressing material, and

a counter-pressure plate as an abutment for the pressing force exerted by the pressing tool.

During the processing of pressing material containing binder reaction gases are produced during the cross-linking of the binders. Since the pressing material, which is usually present in the form of bulk material, is compressed, the air which is compressed with it and heated in the press mould must be removed from the friction lining. During the compression of the pressing material, which usually proceeds under pressure and temperature, hydrogen or other reaction gases, e.g. ammonia, can be produced due to other components. These gases must also be removed from the friction lining. In the past this took place between the individual pressing operations, since drawing off of the gases is necessary for the progress of binder reactions and for the production of a homogeneous friction lining. In the past the procedure was such that the pressing tool, i.e. the press ram, is opened against the pressing movement and closed again after the degassing of the friction lining. When pressure and heat are applied again further gases may be produced, and these must likewise be drawn off. The degassing stroke of the press ram is repeated. This is time-consuming. Long overall pressing times are the result. Moreover, the reactions in the pressing material can only proceed at intervals during compression of the pressing material to form the friction lining. In some circumstances this leads to incomplete curing of the friction lining and to inhomogeneities in the friction lining.

The known type of degassing has a further disadvantage. Due to the hot smooth surface of the press ram the surface of the friction lining is often so smooth as to be “glassy” and thus has poor permeability for gas diffusion. However, the gases must diffuse out of the friction lining against the pressing direction—that is to say over the smooth surface. As has been stated, this is not readily possible. Because of the low inherent strength of the friction lining at the time of degassing, the internal gas pressure can lead to cracks, bubbles and delaminations. A friction lining with such defects is unusable.

In order to avoid the described disadvantages, a method of producing brake linings has been developed (DE 199 53 438 A1) in which degassing of the friction lining takes place continuously during the pressing stroke. The degassing of the friction lining takes place during the pressing operation via bores constructed in the press ram. In this way the mass production of brake linings has been improved, particularly with regard to the pressing time, by comparison with degassing by opening the pressing tool. However, inhomogeneities leading to rejection of friction linings can still occur.

The object of the invention is to improve the quality of the friction linings produced whilst maintaining the shortest possible pressing times.

In order to achieve this object, the method referred to in the introduction is characterised in that the gaseous or vaporous media to be drawn off are drawn off during and/or after the pressing operation radially or/and via the side of the friction lining facing away from the pressing tool, the pressure exerted by the pressing tool on the friction lining being maintained at least at a reduced level.

The invention combines several advantages. On the one hand the pressing times can be kept to a minimum. There is no need for venting cycles, that is to say no moving of the pressing tool into and out of the mould. On the contrary, degassing can take place continuously. Due to the action of the pressing tool (that is to say by supply of pressure and heat) during the entire pressing operation the friction lining can cure homogeneously. In particular, the reactions taking place at an elevated temperature proceed completely and within the shortest possible time. The curing process is favoured by the fact that the surfaces of the lining are constantly in contact with the heated tool. Thus separate curing can be omitted.

A further advantage lies in the high quality of the friction linings produced. Because the pressure is maintained at least at a reduced level, the internal gas pressure cannot destroy the lining—unlike in the prior art. There are considerably fewer rejects. Furthermore, the compressibility of the friction lining can be set specifically by adjustment of the clamping force and/or the clamping path.

The friction lining can emit gas via its entire radial area. The invention is based on the recognition that in a direction at right angles to the pressing direction the friction lining has the lowest diffusion resistance for the enclosed gases due to the structure generated in the pressing material during pressing. Cracks, bubbles, delaminations, etc., in the surface regions of the friction lining are markedly reduced.

As an alternative or in addition to this, it is possible to draw off the gaseous or vaporous media during and/or after the pressing operation via the side of the friction lining facing away from the pressing tool. The side of the friction line facing away from the pressing tool cures “last” and allows complete degassing of the friction lining. Also as a result any damage is effectively prevented particularly to the surface regions of the side of the friction lining facing the pressing tool.

In a preferred further development of the invention it is proposed that at least during a phase of the pressing operation between the friction lining and an appertaining complementary lateral wall of the mould a gap is produced into which the gaseous or vaporous media enclosed in the pressing material diffuse out and are then drawn off. Already after a short shaping phase of the friction lining, the side wall thereof can also be completely exposed radially, as is preferably proposed. The pressure and optionally the introduction of heat via the end face of the friction lining are maintained at least at a reduced level.

The invention is suitable for friction linings of all types. However, it is directed in particular to brake linings or clutch linings. Brake linings for drum brakes can be produced according to the invention in just the same way as disc brake linings. In a preferred embodiment of the invention, therefore, it is proposed that preferably after the pressing material has been filled into the mould the latter is provided with a support plate and the gaseous or vaporous media are drawn off out of the mould radially and/or via openings constructed in the support plate. During the compression of the pressing material the friction material is joined to the support plate, either by an adhesive layer or by the adhesive properties of the pressing material.

The support plate is preferably supplied with pressure by way of a counter-pressure plate acting against the pressing tool, and the gaseous or vaporous media are drawn off between the support plate and the counter-pressure plate towards the surrounding atmosphere. For this purpose a channel can be provided in the counter-pressure plate or in the support plate (or in both). The channel creates a connection between the openings in the support plate and the surrounding atmosphere. Since the channel or channels only occupy a very small surface area in contrast to the overall effective surface, they are entirely uncritical both for the contact region and also for the support plate.

As an alternative or in addition, the gaseous or vaporous media can also be drawn off to the atmosphere through the counter-pressure plate. In the production of a friction lining with a support plate the openings in the counter-pressure plate are preferably aligned with the openings constructed in the support plate.

In order to achieve the object the apparatus according to the invention which is referred to in the introduction is characterised in that a radial peripheral wall is provided for lateral shaping of the friction lining and can be displaced relative to the press ram and to the counter-pressure plate or vice versa. After a short shaping phase of the friction lining the peripheral wall can be “lowered”, so that the sides of the friction lining are then exposed for degassing. A gap is produced into which gases or vapours diffuse out. The gap can be enlarged to such an extent that the side surfaces of the friction lining are completely exposed. Naturally it is possible—although more complex—to keep the peripheral wall stationary and to move the press ram together with the counter-pressure plate relative to the peripheral wall.

The object is also achieved by an apparatus as referred to in the introduction in which at least one opening which creates a connection between at least a part-zone of the friction lining surface and the surrounding atmosphere is associated with the side of the friction lining facing the counter-pressure plate. As already mentioned previously, it may advantageously be provided that channel-like depressions which connect at least a part-zone of the friction lining laterally to the surrounding atmosphere are constructed in the side of the counter-pressure plate facing the friction lining. The channel-like depression can be constructed for example as grooves through which the friction lining is degassed.

In order to produce a disc brake lining it is proposed that between the counter-pressure plate and the pressing material there is disposed a support plate which is supported on one side against the counter-pressure plate and is supplied from the other side with the pressing material, the support plate and the pressing material forming the friction lining.

The friction lining can be degassed radially in the described manner. For alternative or additional degassing the support plate has at least one support plate opening through which the gaseous or vaporous media are drawn off.

The support plate openings advantageously have a shape which widens outwards like a funnel and can be produced during a simple punching operation. The counter-pressure plate can be provided with projections which preferably engage partially in the support plate openings, leaving a residual gap through which the gases can escape.

Finally, in a significant further development of the invention it is proposed that the counter-pressure plate has at least one through opening which connects at least a part-zone of the friction lining to the surrounding atmosphere. Thus the gases are led through the counter-pressure plate to the surrounding atmosphere. The through openings are advantageously aligned with the support plate openings.

An insert, a so-called stopper ram, can be inserted into the through opening in the counter-pressure plate. An annular gap remains between the stopper ram and the through opening. The counter-pressure plate is provided on its side facing away from the friction lining with a groove which leads the gases from the annular gap outwards. The annular gap is set so that no pressing material or friction material can escape into the gap between the stopper ram and the counter-pressure plate.

The area at which the gases escape can be wear. Therefore when the stopper ram shows signs of wear it is simply removed and replaced by a new stopper ram.

The invention is explained in greater detail in the following description with reference to a preferred embodiment in conjunction with the appended drawings, in which:

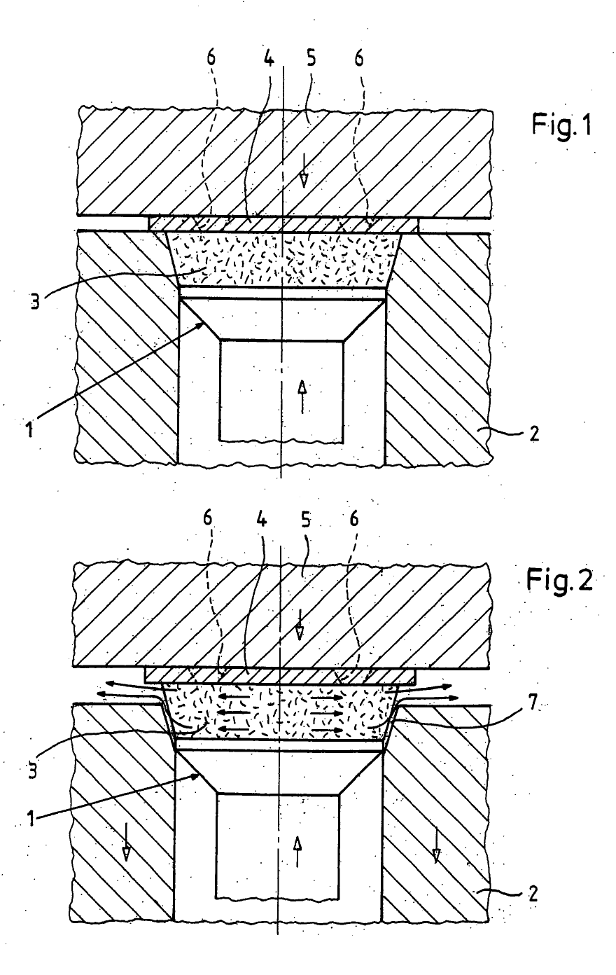

FIGS. 1 and 2 shows a schematic sectional view through a first embodiment of an apparatus according to the invention in the completely closed press end position and a subsequent degassing position in which the gases included in the friction lining can diffuse out radially;

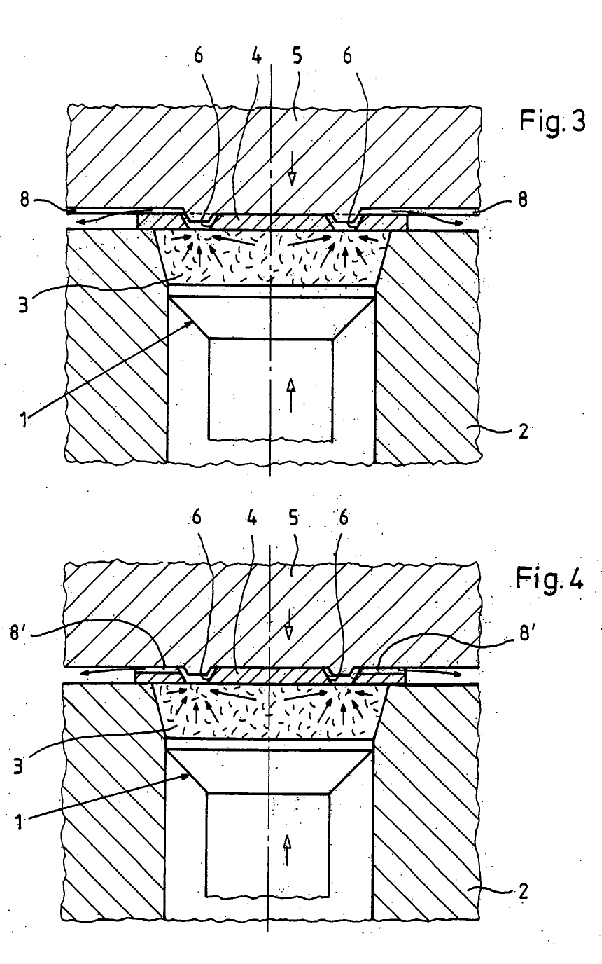

FIG. 3 shows a second embodiment of a pressing apparatus according to the invention in which the gases and/or vapours are drawn off through the counter-pressure plate;

FIG. 4 shows a third embodiment which is modified relative to the embodiment according to FIG. 3 and in which the gases or vapours are drawn off from the friction lining via channels in the rear face of the support plate;

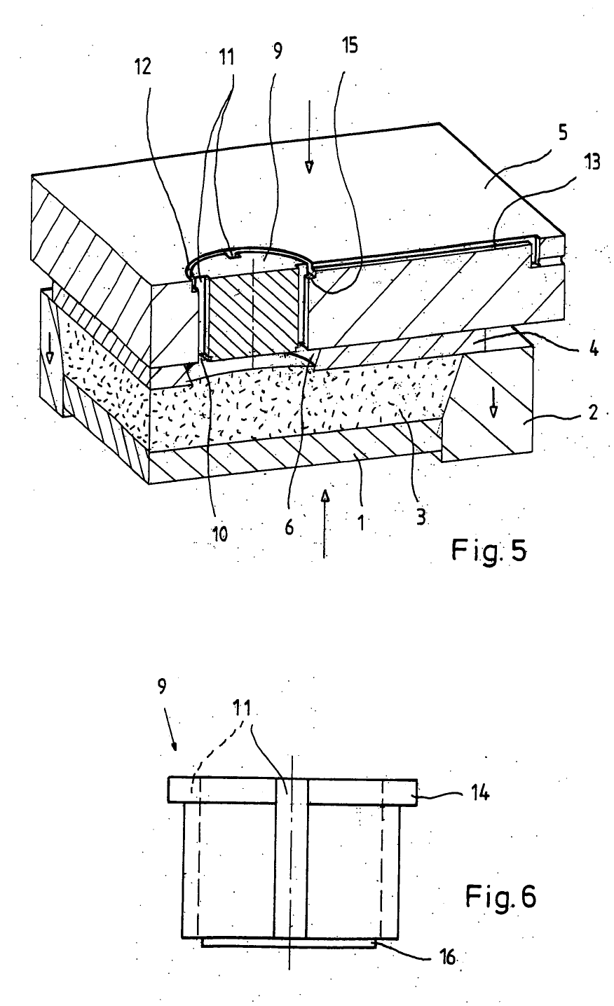

FIG. 5 shows a schematic perspective sectional view through a fourth embodiment in which the gases or vapours are drawn off through the counter-pressure plate; and

FIG. 6 shows a side view of a stopper ram as inserted into the counter-pressure plate in FIG. 5, but on an enlarged scale.

A pressing apparatus for producing brake linings for disc brakes of motor vehicles is shown in FIG. 1. The pressing apparatus has a press ram 1 which is movable relative to a peripheral wall 2. The peripheral wall is kept stationary. It forms together with the ram 1 a receptacle or mould for pressing material 3 which is present in the initial state as bulk material and which forms the friction lining after compression by the press ram.

A support plate 4 made from metal rests on the peripheral wall 2. During the compression of the pressing material 3 the pressing material is applied so as to adhere firmly to the support plate 4. The counter-pressure of the ram 1 during compression is applied by way of a counter-pressure plate 5.

In detail, a brake lining is produced as follows: first of all the ram 1 is in a lowered position. The mould formed by the press ram 1 and the peripheral wall 2 is open at the top. A defined quantity of pressing material 3 is filled into the mould. Then the support plate 4 is placed on the peripheral wall 2 and pretensioned by the counter-pressure plate 5. The press ram 1 then compresses the pressing material against the support plate 4. In this case the pressing material can already be compressed to for example ⅕ of its volume.

Openings 6 are constructed in the support plate 4 into which the pressing material can penetrate at least slightly during compression and thus creates an additional mechanical anchoring. As a rule the openings 6 are punched and therefore are of slightly conical construction. The openings 6 are not obligatory. They do form a positive-locking connection between the friction lining and the support plate 4 (an in particular a high resistance to shear forces), although the positive-locking connection between the friction lining and the support plate is quite sufficient for a reliable connection.

The press ram 1 is heated during the pressing operation. During the pressing operation the pressing material 3 is pressed into the mould and cured with additional heat energy being supplied. In this case gases or vapours are produced which must be drawn off from the mould in order not to lead to damage to the friction lining and thus to rejection thereof.

FIG. 2 shows how according to the invention the peripheral wall 2 is opened in the downward direction for degassing. This can already take place after a short shaping phase of the friction lining in which the friction lining acquires sufficient stability to retain its shape even without the peripheral wall 2. When the peripheral wall 2 is lowered a gap 7 is formed. The gaseous or vaporous media can diffuse out into the gap 7 and are drawn out of the mould. In FIG. 2 the mould is shown only partially open. Naturally, and preferably, the entire side wall of the friction lining can also be exposed either by lowering of the peripheral wall, as illustrated, or by simultaneous raising of the press ram 1 together with the counter-pressure plate 5 and the brake lining held between them.

During the entire venting, the pressure of the press ram 1 is maintained at least at a reduced level. Also the introduction of heat can take place continuously. The result is a homogeneous brake lining of excellent quality which can be produced in the shortest possible time.

If for any reason the pressing material 3 should not be completely solidified—that is to say stable in shape—then after the peripheral wall 2 has been lowered it can also be raised again to close the mould in order to stabilise the radial shape of the lining.

When the friction lining is completely solidified and the unwanted gaseous components have diffused out, the finished brake lining can be removed from the mould.

The embodiment of the apparatus shown in FIG. 3 corresponds to the basic construction of the press mould shown in FIGS. 1 and 2, so that in order to avoid unnecessary repetitions only the modifications which have been made will be described, whilst for other matters reference may be made to the preceding description of FIGS. 1 and 2. The components which correspond in functional terms are given the same reference numerals in the drawings.

In the embodiment according to FIG. 3 the degassing the resulting friction lining should take place continuously during the pressing operation via the through openings 6 in the support plate 4. In order to achieve this channel-like depressions 8 are produced in the pressure surface of the counter-pressure plate 5 abutting the support plate 4. The said depressions are led from the zone of the counter-pressure plate 5 lying close to the through openings 6 to the outer atmosphere.

In each of its zones lying opposite the through openings 6 of the support plate the counter-pressure plate 5 has a projection in the shape of a truncated cone which engages in the through opening 6 during the pressing operation. The projections have a smaller cross-section that the through openings 6, so that they do not completely close the through openings 6. The gases and vapours can diffuse out in this way. It should be pointed out that a projection is not absolutely necessary. A substantially planar surface over the through openings 6 is likewise preferred.

FIG. 4 shows an embodiment in which channel-like depressions 8′ are made in the flat face of the support plate 4 facing the counter-pressure plate 5. Otherwise this embodiment corresponds completely to the previously described embodiment, that is to say the gaseous or vaporous inclusions in the pressing material are drawn off continuously during the pressing operation via the through openings 6 and the channel-like depressions 8′ which extend from the through openings 6 to the edge of the respective support plate 4.

FIG. 5 illustrates a further possibility for drawing off gaseous or vaporous media. The press mould is shown closed.

A stopper ram 9 which is substantially aligned with the through opening 6 in the support plate 4 is inserted into the pressure plate 5. The stopper ram 9 forms together with the counter-pressure plate 5 on its underside a substantially planar plane, wherein a first annular space 10 remains between the stopper ram and the counter-pressure plate. Media which are diffusing out can enter this annular space, and are led off through longitudinal grooves 11 constructed in the stopper ram 9 into a second annular space 12 and from there into a lateral discharge channel 13 to the surrounding atmosphere.

The second annular space 12 is necessary in particular when a component of the pressing apparatus which rests flat on the counter-pressure plate in the region of the stopper ram 9 acts on the counter-pressure plate 5. The gases are drawn off through the annular space 12 and the channel 13 “below” the upper face of the counter-pressure plate 5.

The stopper ram 9 is subject to some wear. Moreover, it can be used in order by means of impressions formed on its underside to identify the brake lining by stamping friction material coming into the support plate opening 6. Such an identification can for example include the type of friction material or it may meet other customer-specific requirements.

In FIG. 6 the stopper ram 9 is shown by itself on an enlarged scale. The illustrated stopper ram 9 has four grooves 11. Naturally, one groove 11 is already sufficient, but care should be taken that pressing material 3 can enter into the first annular space 10 between the stopper ram 9 and the counter-pressure plate 5 and may close off the sole groove 11. Therefore a plurality of grooves 11 are advisable for more reliable and more uniform drawing off the gases. The stopper ram 9 has on its upper face a peripheral step 14 with which it rests on a should 15 of the counter-pressure plate 5 (FIG. 5). On its lower face the stopper ram 9 has a projection 16 in which for example an impression can be made for identification of the brake lining.

Modifications are of course possible within the scope of the invention. Thus radial venting of the brake lining can take place not only by lowering of the peripheral wall 2 but also—as already mentioned—by “moving out” the brake lining gripped between the press ram 1 and the counter-pressure plate 5. Also the pressing apparatus is not fixed in the orientation illustrated in the drawings. Filling of the pressing material 3 from above onto a counter-pressure plate 5 or support plate 5 already resting on the peripheral wall 2 is also conceivable. Finally, it should be explicitly pointed out again that the invention has been described in connection with a brake lining with a support plate 4, but the support plate 4 does not necessarily have to be a component of the brake lining. Accordingly the invention can also be applied for example to the production of drum brake linings (which have no support plate).

1-16. (canceled)

17. A Method of producing friction linings made from pressing material bonded by means of a binder, comprising the steps of:
filling the pressing material into a mould,
pressing the pressing material with at least one ram-like pressing tool, and
drawing off gaseous or vaporous media which are contained in the mould or are produced during the pressing operation from the mould, while the pressure exerted by the pressing tool on the friction lining is maintained at least at a reduced level, wherein the gaseous or vaporous media to be drawn off diffuse out and are then drawn off through a gap which is produced at least at times during the pressing operation between the friction lining and an appertaining complementary lateral wall of the mould.

18. The Method of claim 17, wherein the gaseous or vaporous media to be drawn off are drawn off during the pressing operation via the side of the friction lining facing away from the pressing tool.

19. The Method of claim 18, wherein
after the pressing material has been filled into the mould the latter is provided with a support plate, and
the gaseous or vaporous media are drawn off out of the mould via openings constructed in the support plate

20. The Method of claim 19, wherein
the support plate is supplied with pressure by way of a counter-pressure plate acting against the pressing tool, and
the gaseous or vaporous media are drawn off between the support plate and the counter-pressure plate towards the surrounding atmosphere.

21. The Method of claim 19, wherein
the support plate is supplied with pressure by way of a counter-pressure plate acting against the pressing tool, and
the gaseous or vaporous media are drawn off to the atmosphere through the counter-pressure plate.

22. An Apparatus for producing friction linings made from pressing material bonded by means of a binder comprising:
a mould to receive the pressing material,
a ram-like pressing tool which can be moved in and out of the mould and compresses the pressing material,
a counter-pressure plate as an abutment for the pressing force exerted by the pressing tool, and
a radial peripheral wall for lateral shaping of the friction lining, wherein said radial-peripheral wall can be displaced relative to the press ram and to the counter-pressure plate or vice versa during the pressing operation, so that a lateral gap is produced.

23. The Apparatus of claim 22, wherein channel-like depressions which connect at east a part-zone of the friction lining laterally to the surrounding atmosphere are constructed in the side of the counter-pressure plate facing the friction lining.

24. The Apparatus of claim 22, wherein during the compression between the counter-pressure plate and the pressing material there is disposed a support plate which is supported on one side against the counter-pressure plate and is supplied from the other side with the pressing material, the support plate and the pressing material being connected to form the friction lining.

25. The Apparatus of claim 24, wherein at least one support plate opening for drawing off the gaseous or vaporous media is constructed in the support plate between the counter-pressure plate and the pressing material.

26. The Apparatus of claim 22, wherein the counter-pressure plate has at least one through opening which connects at least a part-zone of the friction lining to the surrounding atmosphere.

27. The Apparatus of claim 26, wherein the through opening is formed between a removable insert received in the counter-pressure plate and the counterpressure plate.

28. An Apparatus for producing friction linings made from pressing material bonded by means of a binder, comprising:
a mould to receive the pressing material,
a ram-like pressing tool which can be moved in and out of the mould and compresses the pressing material,
a counter-pressure plate as an abutment for the pressing force exerted by the pressing tool, and
at least one opening creating a connection between at least a part-zone of the friction lining surface and the surrounding atmosphere and being associated with the side of the friction lining facing the counter-pressure plate.

29. The Apparatus of claim 28, wherein channel-like depressions which connect at least a part-zone of the friction lining laterally to the surrounding atmosphere are constructed in the side of the counter-pressure plate facing the friction lining.

30. The Apparatus of claim 28 wherein during the compression between the counter-pressure plate and the pressing material there is disposed a support plate which is supported on one side against the counter-pressure plate and is supplied from the other side with the pressing material, the support plate and the pressing material being connected to form the friction lining.

31. The Apparatus of claim 30, wherein at least one support plate opening for drawing off the gaseous or vaporous media is constructed in the support plate between the counter-pressure plate and the pressing material.

32. The apparatus of claim 28, wherein the counter-pressure plate has at least one through opening which connects at least a part-zone of the friction lining to the surrounding atmosphere.

33. The Apparatus of claim 32, wherein the through opening is formed between a removable insert which is received in the counter-pressure plate and the counter-pressure plate.

34. A Method of producing friction linings made from pressing material bonded by means of a binder, comprising:
filling the pressing material into a mould,
pressing the pressing material with at least one ram-like pressing tool, and drawing off gaseous or vaporous media which are contained in the mould or are produced during the pressing operation from the mould, while the pressure exerted by the pressing tool on the friction lining is maintained at least at a reduced level, wherein the gaseous or vaporous media to be drawn off are drawn off during the pressing operation via the side of the friction lining facing away from the pressing tool.

35. The Method of claim 34, wherein
after the pressing material has been filled into the mould the latter is provided with a support plate, and
the gaseous or vaporous media are drawn off out of the mould via openings constructed in the support plate.

36. The Method of claim 35, wherein
the support plate is supplied with pressure by way of a counter-pressure plate acting against the pressing tool, and
the gaseous or vaporous media are drawn off between the support plate and the counter-pressure plate towards the surrounding atmosphere.

37. The Method of claim 35, wherein
the support plate is supplied with pressure by way of a counter-pressure plate acting against the pressing tool, and
the gaseous or vaporous media are drawn off to the atmosphere through the counter-pressure plate.
